(19) United States
(12) Patent Application Publication
(10) Pub. No.: US 2025/0002096 A1
(43) Pub. Date: Jan. 2, 2025

(54) TAILGATE DEVICE WITH EXTENSION ASSEMBLY AND RELATED METHODS

(71) Applicant: BRANDON JOHNS, SAINT CLOUD, FL (US)

(72) Inventor: BRANDON JOHNS, SAINT CLOUD, FL (US)

(21) Appl. No.: 18/754,351

(22) Filed: Jun. 26, 2024

Related U.S. Application Data
(60) Provisional application No. 63/510,707, filed on Jun. 28, 2023.

(51) Int. Cl. B62D 33/08; B62D 33/027

(52) U.S. Cl. CPC B62D 33/08; B62D 33/0273

(57) ABSTRACT

A tailgate device includes a tailgate housing with a first longitudinal side pivotably coupled to a distal end of a truck bed. The tailgate housing provides access to the truck bed. The tailgate device also includes an extension assembly carried by the tailgate housing and having a panel having a first panel longitudinal side, a second panel longitudinal side opposite of the first panel longitudinal side, a first panel end between the first and second panel longitudinal sides, and a second panel end opposite the first panel end and between the first and second panel longitudinal sides. The first panel longitudinal side is pivotably coupled to the second longitudinal side of tailgate housing. The extension assembly also includes a first side panel pivotably coupled to the first end of the tailgate housing, and a second side panel pivotably coupled to the second end of the tailgate housing.

### RELATED APPLICATION

This application is based upon prior filed Application No. 63/510,707 filed Jun. 28, 2023, the entire subject matter of which is incorporated herein by reference in its entirety.

### TECHNICAL FIELD

The present disclosure relates to the field of vehicle accessories, and, more particularly, to a tailgate device and related methods.

### BACKGROUND

Trucks are the most popular vehicle type sold in the United States. Because of the popularity of trucks, the truck accessory industry is quite mature and varied. One functional aspect of trucks that receives enhanced attention is the truck bed. Given the flexible nature of the truck bed, many truck bed accessories are available.

### SUMMARY

Generally, a tailgate device is for a vehicle with a truck bed. The tailgate device comprises a tailgate housing having a first longitudinal side, a second longitudinal side opposite of the first longitudinal side, a first end between the first and second longitudinal sides, and a second end opposite the first end and between the first and second longitudinal sides. The first longitudinal side is pivotably coupled to a distal end of the truck bed, and the tailgate housing provides access to the truck bed. The tailgate device also includes an extension assembly carried by the tailgate housing. The extension assembly comprises a panel having a first panel longitudinal side, a second panel longitudinal side opposite of the first panel longitudinal side, a first panel end between the first and second panel longitudinal sides, and a second panel end opposite the first panel end and between the first and second panel longitudinal sides. The first panel longitudinal side is pivotably coupled to the second longitudinal side of tailgate housing. The extension assembly also includes a first side panel pivotably coupled to the first end of the tailgate housing, and a second side panel pivotably coupled to the second end of the tailgate housing. Advantageously, the extension assembly may extend distally from the truck bed.

Another aspect is directed to making a tailgate device is for a vehicle with a truck bed. The method includes forming a tailgate housing having a first longitudinal side, a second longitudinal side opposite of the first longitudinal side, a first end between the first and second longitudinal sides, and a second end opposite the first end and between the first and second longitudinal sides. The first longitudinal side is pivotably coupled to a distal end of the truck bed, and the tailgate housing provides access to the truck bed. The method includes coupling an extension assembly carried by the tailgate housing. The extension assembly comprises a panel having a first panel longitudinal side, a second panel longitudinal side opposite of the first panel longitudinal side, a first panel end between the first and second panel longitudinal sides, and a second panel end opposite the first panel end and between the first and second panel longitudinal sides. The first panel longitudinal side is pivotably coupled to the second longitudinal side of tailgate housing. The extension assembly also includes a first side panel pivotably coupled to the first end of the tailgate housing, and a second side panel pivotably coupled to the second end of the tailgate housing.

### BRIEF DESCRIPTION OF THE DRAWINGS

FIG. 1 is a schematic perspective view of an example embodiment of a tailgate device, according to the present disclosure.

FIG. 2 is another schematic perspective view of the tailgate device of FIG. 1.

FIG. 3 is another schematic perspective view of the tailgate device of FIG. 1 with the panel pivoted upward.

FIG. 4 is another schematic perspective view of the tailgate device of FIG. 1 with the panel, and the first and second side panels pivoted upward.

FIG. 5 is another schematic perspective view of the tailgate device of FIG. 1 with the first and second side panels extended proximally.

FIG. 6 is another schematic perspective view of the tailgate device of FIG. 1 with the panel pivoted downward.

FIG. 7 is another schematic perspective view of the tailgate device of FIG. 1 with the first and second side panels, and the floor panel extended upward.

FIG. 8 is another schematic perspective view of the tailgate device of FIG. 1 with the first and second side panels, and the floor panel extended outward, and with the tailgate housing removed.

FIG. 9 is a schematic perspective view of the second rail from the tailgate device of FIG. 1 without the tension cable and the tailgate housing.

FIG. 10 is a schematic perspective view of the second rail from the tailgate device of FIG. 1 without the tailgate housing.

FIGS. 11-12 are schematic perspective views of the second rail from the tailgate device of FIG. 1 without the tailgate housing.

FIG. 13 is another schematic perspective view of the second rail from the tailgate device of FIG. 1 without the tailgate housing and the panel.

FIG. 14 is another schematic perspective view of the second rail from the tailgate device of FIG. 1 without the tailgate housing.

FIG. 15 is a schematic perspective view of the drum from the tailgate device of FIG. 1.

FIG. 16 is another schematic perspective view of the second rail from the tailgate device of FIG. 1 without the tailgate housing.

FIG. 17 is an enlarged schematic perspective view of the second rail from the tailgate device of FIG. 1 without the tailgate housing.

FIG. 18 is an enlarged schematic perspective view of the second rail from the tailgate device of FIG. 1 without the tailgate housing and the tension cable.

FIGS. 19-20 are schematic perspective views of the latch from the tailgate device of FIG. 1.

FIG. 21 is another schematic perspective view of the tailgate device of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

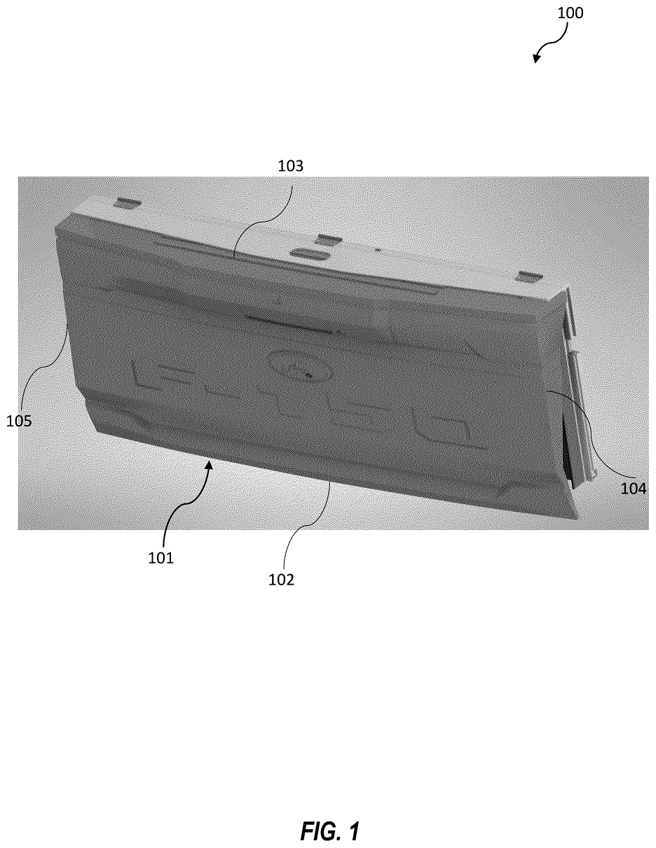

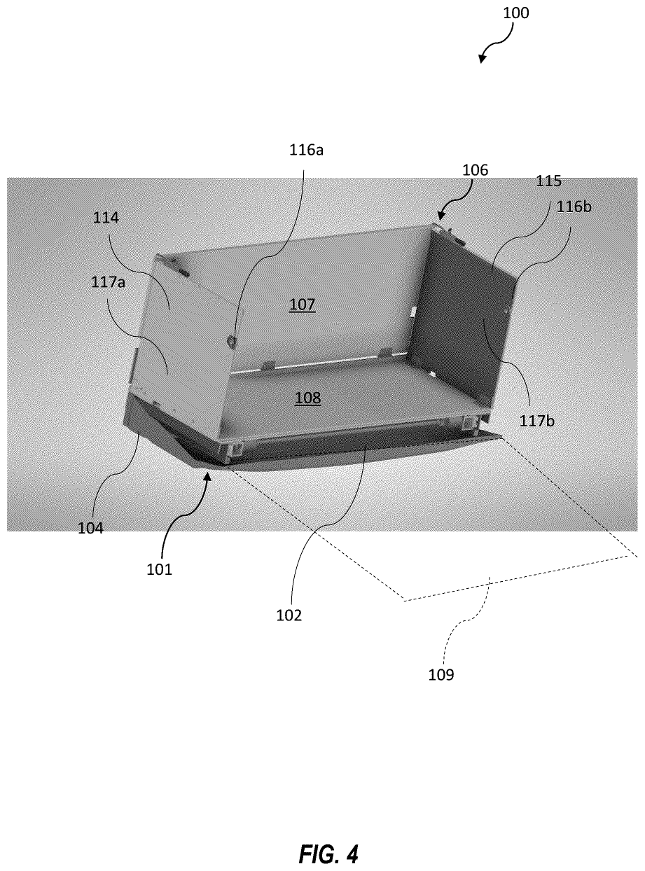

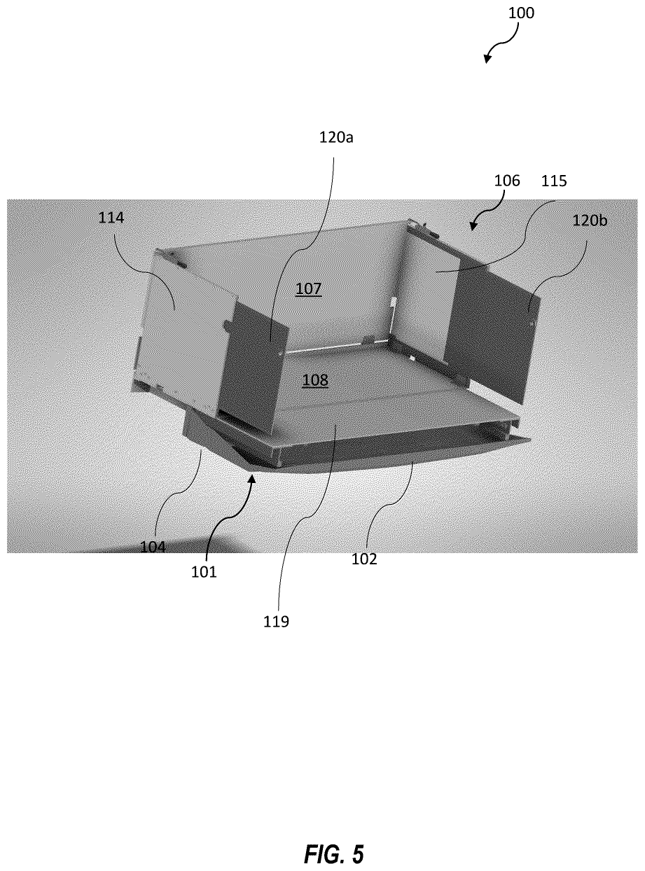

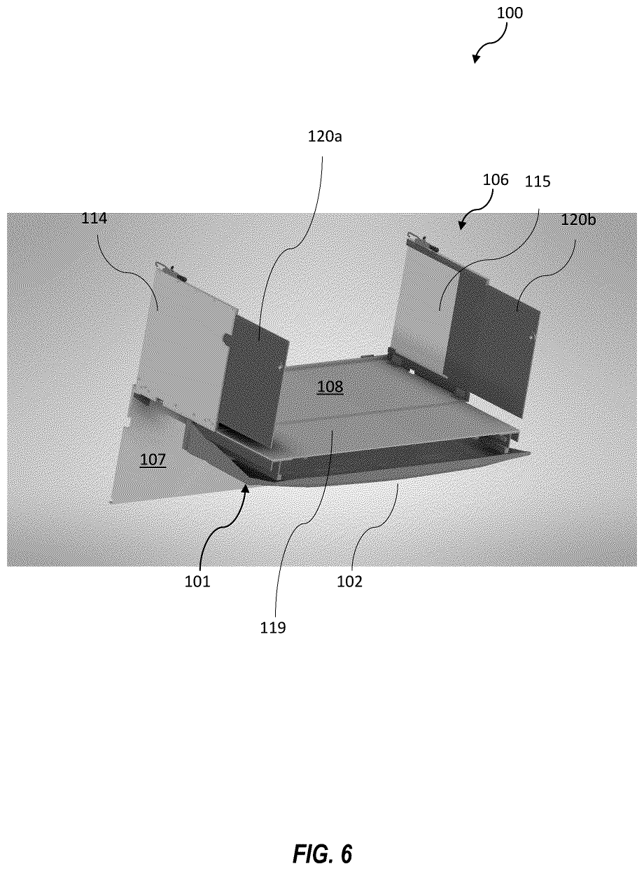

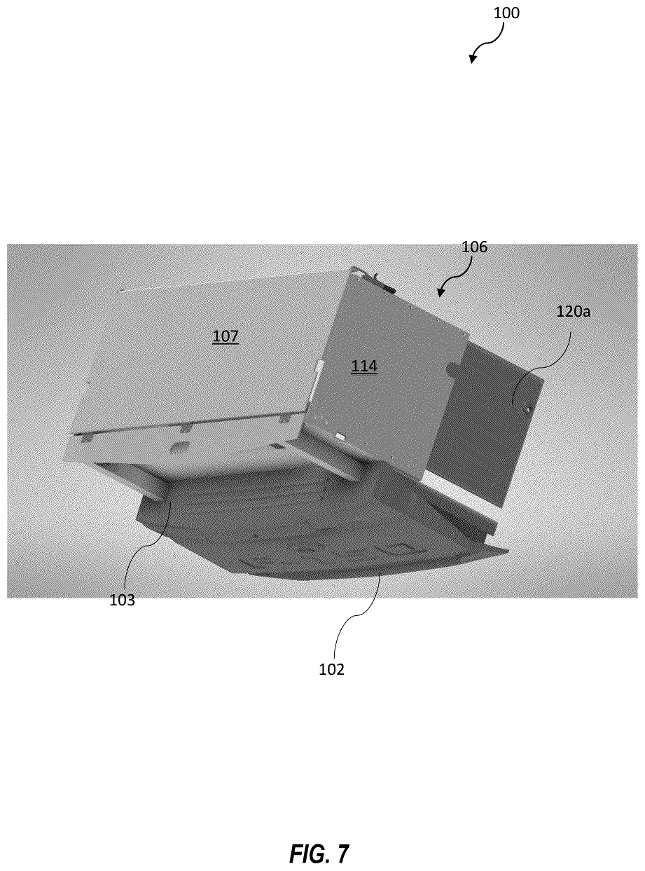

Referring to FIGS. 1-8, a tailgate device 100 according to the present disclosure is now described. As will be appreciated, the tailgate device 100 is for a vehicle with a truck bed 109 (FIG. 4), and may provide longitudinal extension of the truck bed.

The tailgate device 100 comprises a tailgate housing 101 having a first longitudinal side 102, a second longitudinal side 103 opposite of the first longitudinal side, a first end 104 between the first and second longitudinal sides, and a second end 105 opposite the first end and between the first and second longitudinal sides. The tailgate housing 101 may comprise a plurality of housing pieces assembled together, each piece comprising one or more of plastic, resin, and metal.

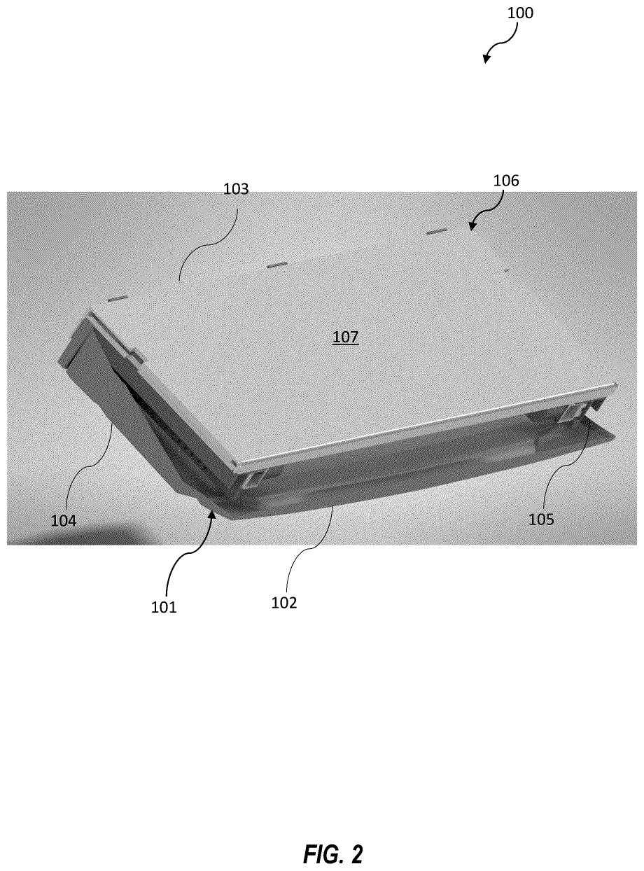

The first longitudinal side 102 is pivotably coupled to a distal end of the truck bed 109 via a hinge, for example. As will be appreciated, while in a retracted state (FIGS. 1-2), the tailgate device 100 operates similarly to a typical tailgate, and the tailgate housing 101 pivots about the distal end of the truck bed 109 to provides access to the truck bed.

The tailgate device 100 also includes an extension assembly 106 carried by the tailgate housing 101. As for materials, each of the components of the extension assembly 106 may comprise one or more of a metal, plastic, resins, or any material with sufficient mechanical strength.

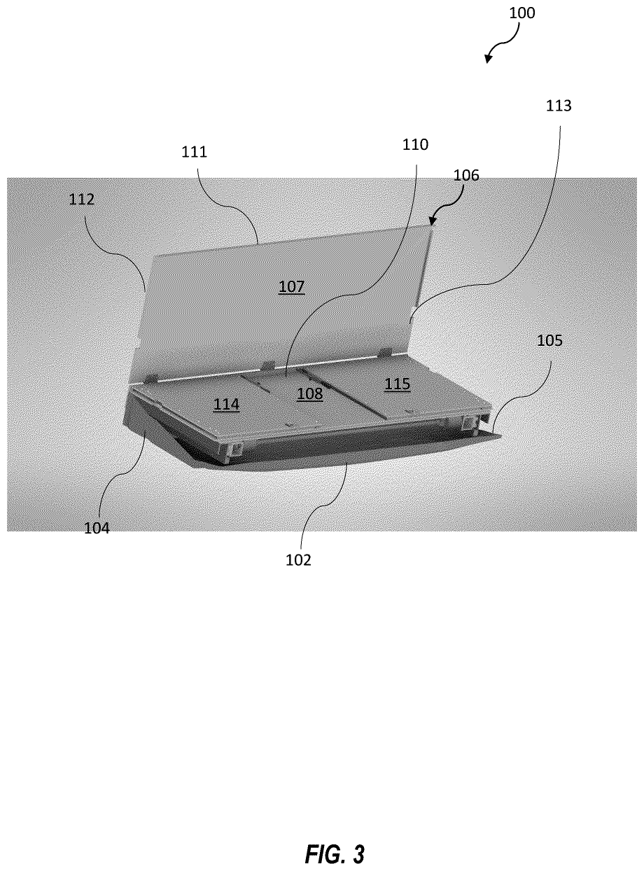

The extension assembly 106 illustratively comprises a panel 107 having a first panel longitudinal side 110, a second panel longitudinal side 111 opposite of the first panel longitudinal side, a first panel end 112 between the first and second panel longitudinal sides, and a second panel end 113 opposite the first panel end and between the first and second panel longitudinal sides. The extension assembly 106 also includes a floor panel 108 carried by and abutting the tailgate housing 101, a first side panel 114 pivotably coupled to a first end of the floor panel via a hinge, for example, and a second side panel 115 pivotably coupled to the second end of the floor panel via a hinge, for example. As perhaps best seen in FIGS. 2-3 & 5-6, the first panel longitudinal side 110 is pivotably coupled to a second longitudinal side of floor panel 108 via a hinge, for example.

Each of the first side panel 114 and the second side panel 115 illustratively includes a socket 116a-116b configured to engage with a tailgate striker bolt of the truck bed 109. Also, each of the first side panel 114 and the second side panel 115 illustratively includes a tension cable 117a-117b respectively coupled between the socket 116a-116b and the second longitudinal side 103 of the tailgate housing 101. Helpfully, the tension cable 117a-117b may structurally support the extension assembly 106 from torsion forces due to loading.

The first side panel 114 and the second side panel 115 illustratively include first and second extension side panels 120a-120b extending respectively from proximal ends thereof. Also, the floor panel 108 illustratively comprises a floor extension panel 119 extending from the first longitudinal side of the floor panel.

When the first and second extension side panels 120a-120b and the floor extension panel 119 are extended, placing the tailgate device 100 in an extended state, the extension assembly 106 extends the capacity of the truck bed 109 in a secure fashion. Also, since the panel 107 is pivotably coupled to a second longitudinal side of floor panel 108, the tailgate device 100 provides easy loading access commensurate with typical tailgates. Further, the tension cables 117a-117b extend as the first and second extension side panels 120a-120b and the floor extension panel 119 extend longitudinally with the truck bed 109. So, even though loads may exert a torsional force on the tailgate device 100 while in the extended state, the tension cables 117a-117b may counter that torsional force, thereby maintaining structural integrity.

Each of the first side panel 114 and the second side panel 115 illustratively includes a latch 121a-121b configured to engage with the first and second panel ends 112-113. When unlatched, the panel 107 freely pivots about the second longitudinal side of the floor panel 108 for loading.

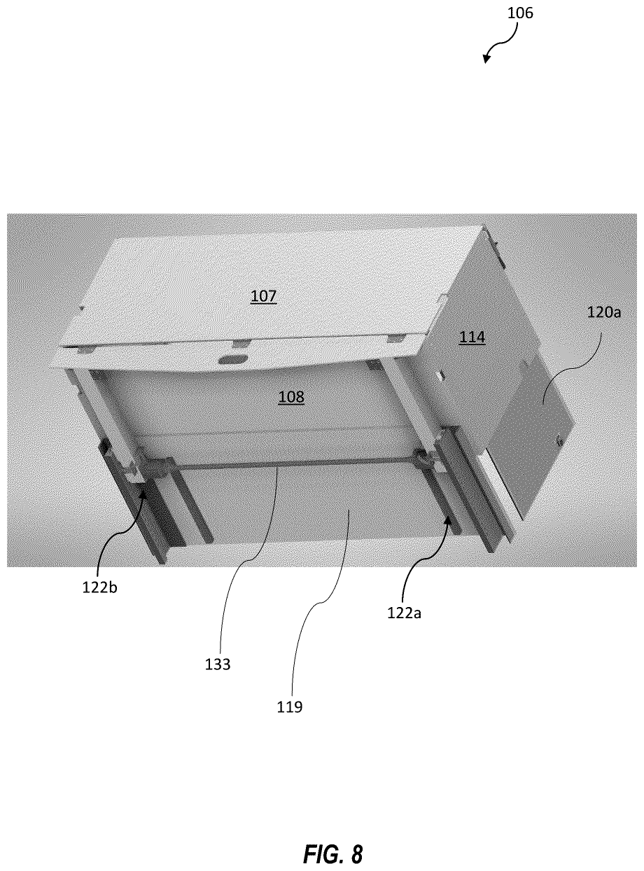

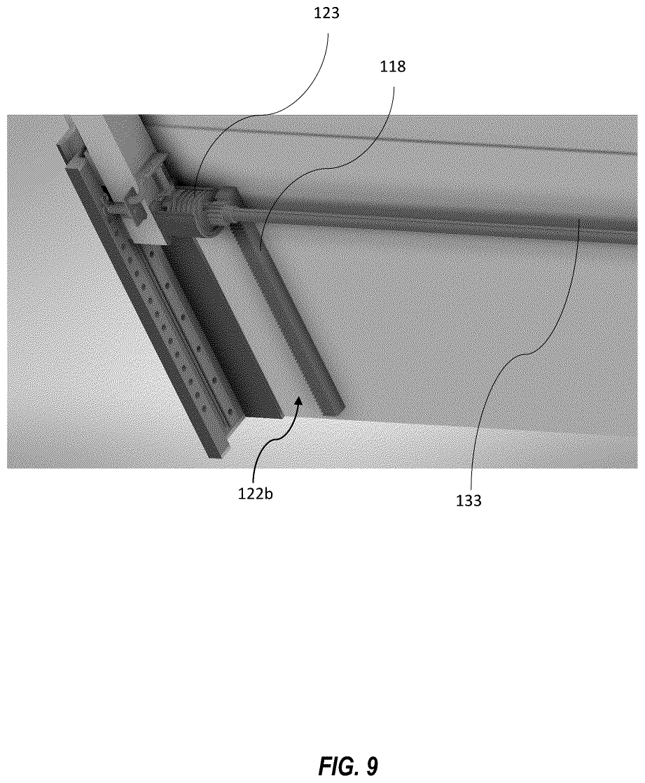

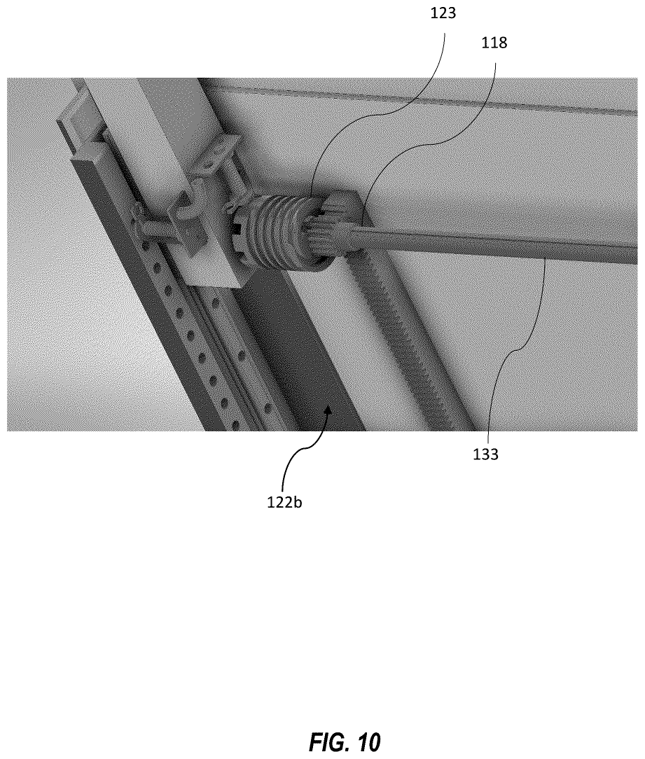

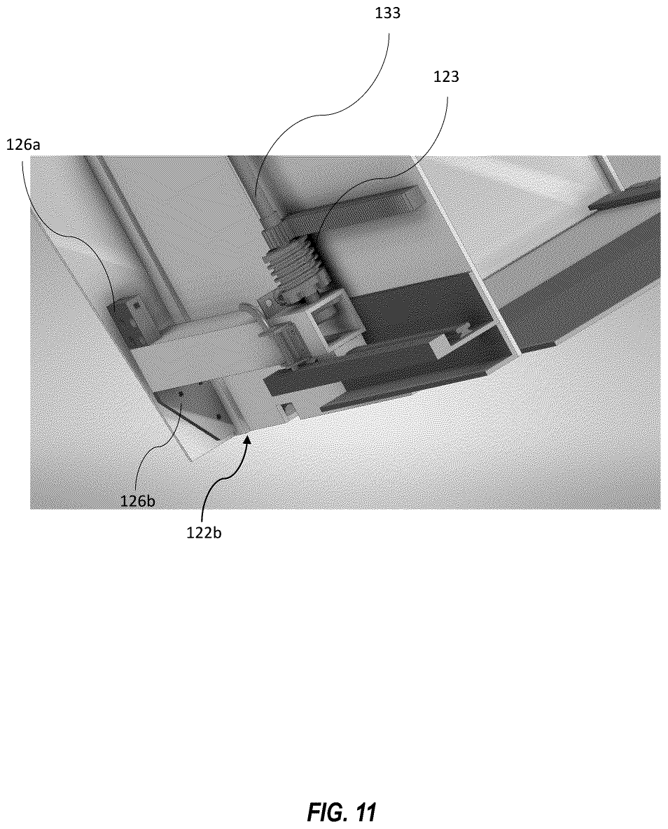

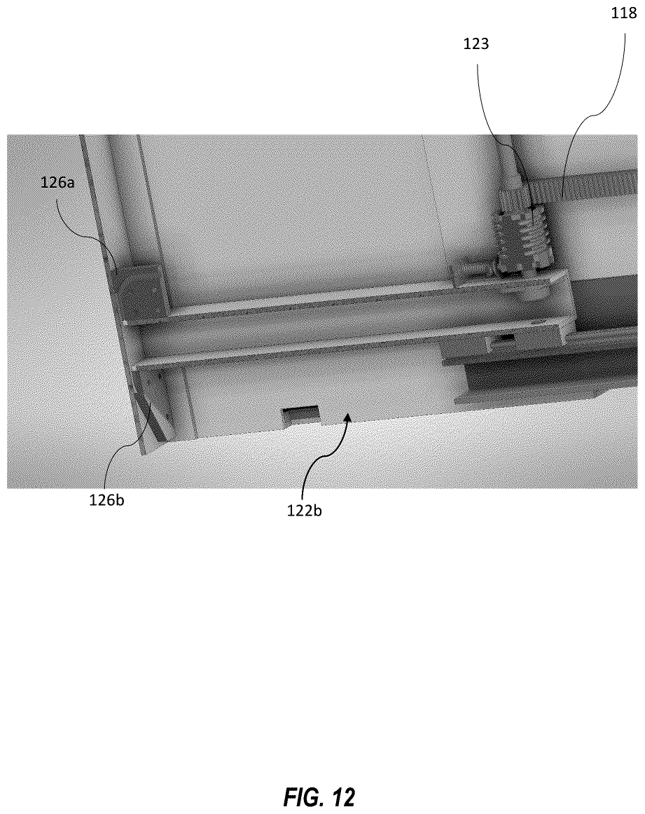

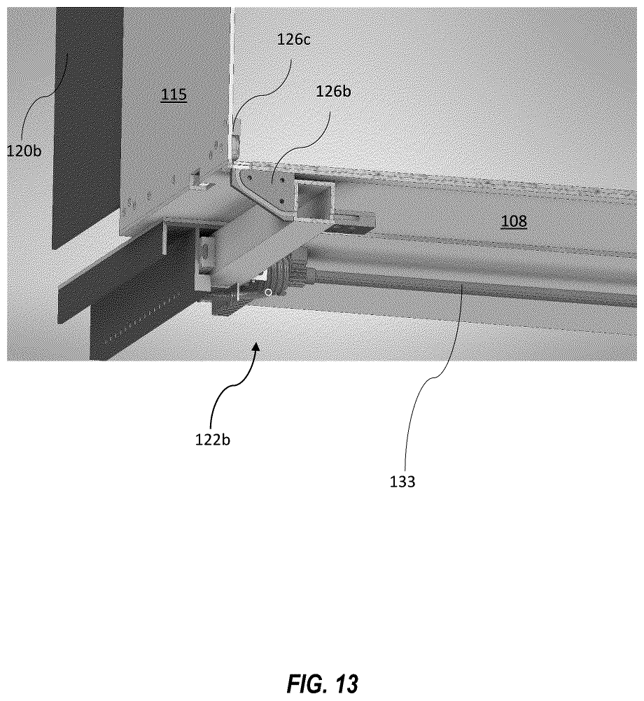

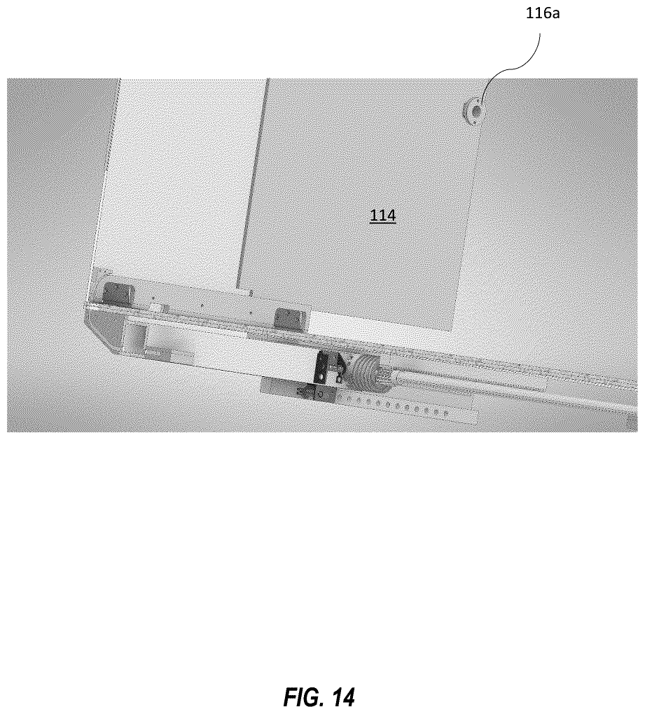

Referring now additionally to FIGS. 8-14, the extension assembly 106 comprises first and second rails 122a-122b carrying the floor panel 108 and the floor extension panel 119 and configured to allow the floor panel and the floor extension panel to freely extend and retract longitudinally from the distal end of the truck bed 109. Each of the first and second rails 122a-122b illustratively comprises a rack and pinion arrangement 118 for easy longitudinal translation, a drum 123 configured to respectively pay out and retract the tension cables 117a-117b, a first locking pin 124 configured to lock the drum in place, and a second locking pin 125 configured to lock the respective longitudinal position of the first and second rails. Each of the first and second rails 122a-122b comprises a mechanical actuator (not shown, e.g., hand lever) configured to selectively engage the first and second locking pins 124-125. Each of the first and second rails 122a-122b comprises a plurality of guide blocks 126a-126c configured to route the tension cables 117a-117b from the drum 123 to the socket 116a-116b via a post 127.

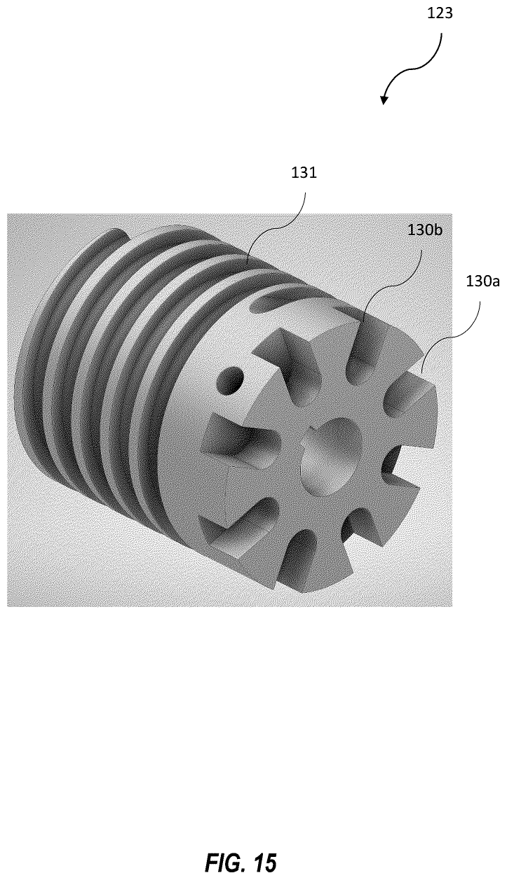

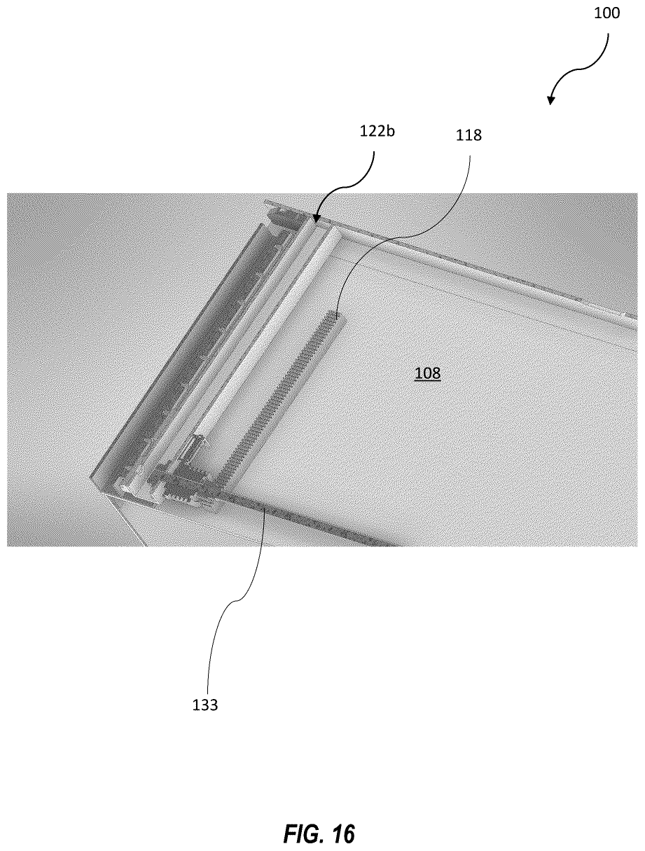

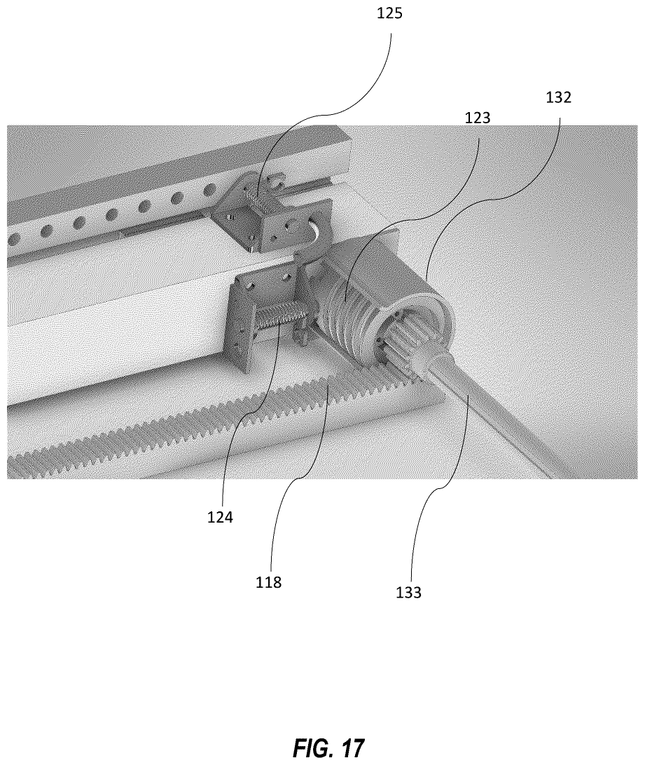

As perhaps best seen in FIGS. 15-17, each drum 123 illustratively includes a plurality of radial notches 130a-130b for receiving the first locking pin 124. Also, each drum 123 illustratively includes an annular groove 131 for receiving the tension cable 117a-117b, and a shroud 132 for covering the annular groove and tension cable wrapped thereon.

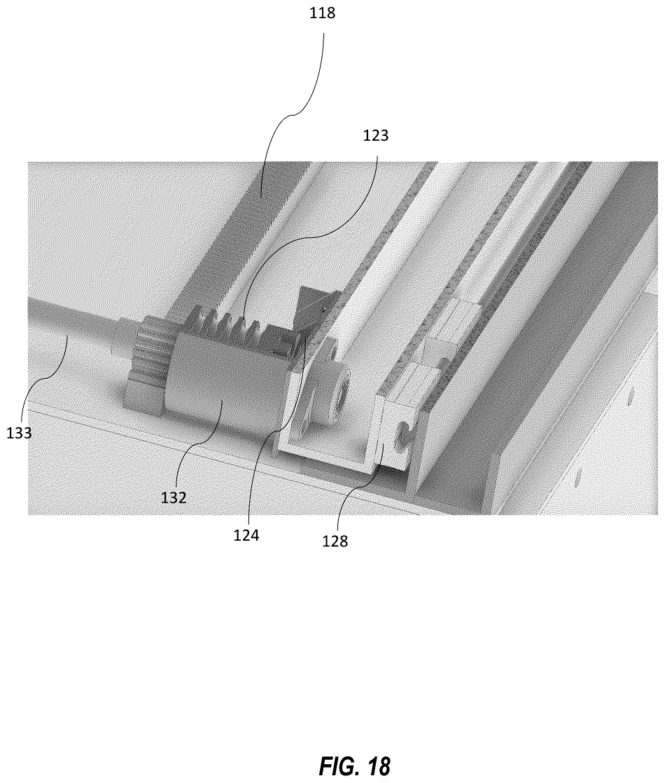

As perhaps best seen in FIG. 18, each of the first and second rails 122a-122b illustratively comprises a tongue and groove arrangement 128 for sliding longitudinally from the distal end of the truck bed 109. Also, the rack and pinion arrangement 118 illustratively includes a shaft 133 extending between the first and second rails 122a-122b, keeping the first and second rails in longitudinal alignment.

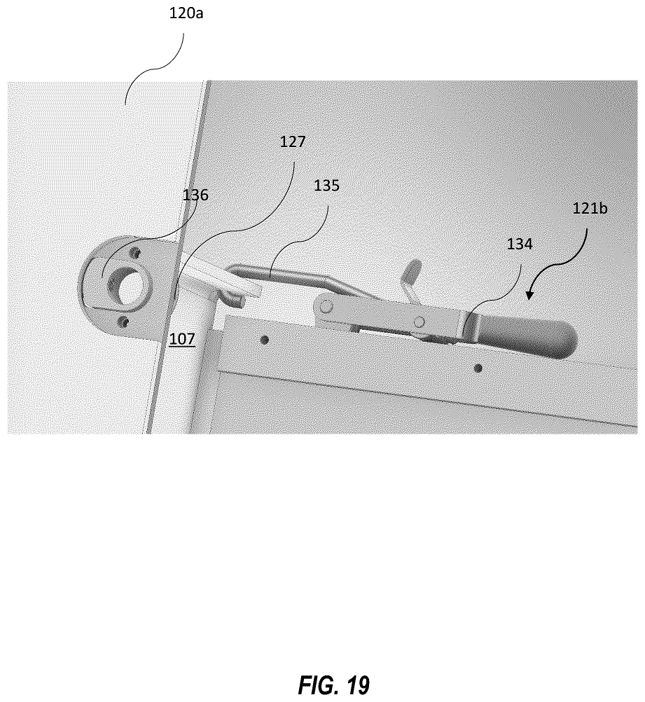

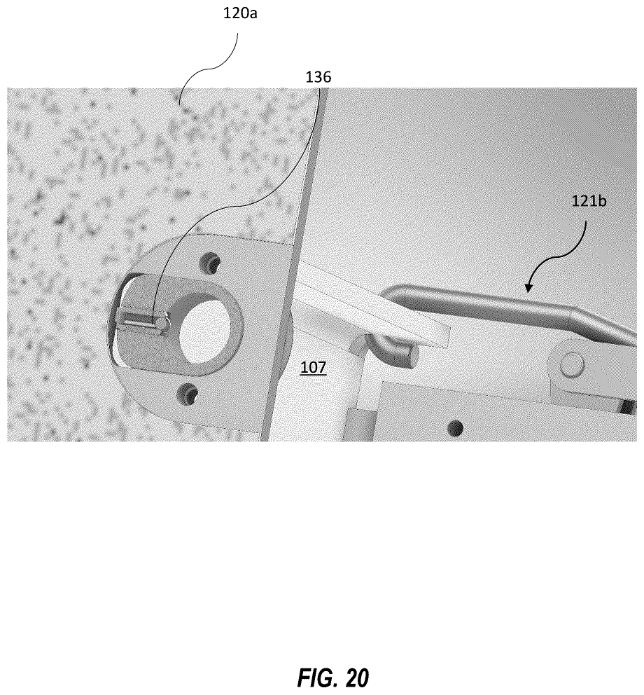

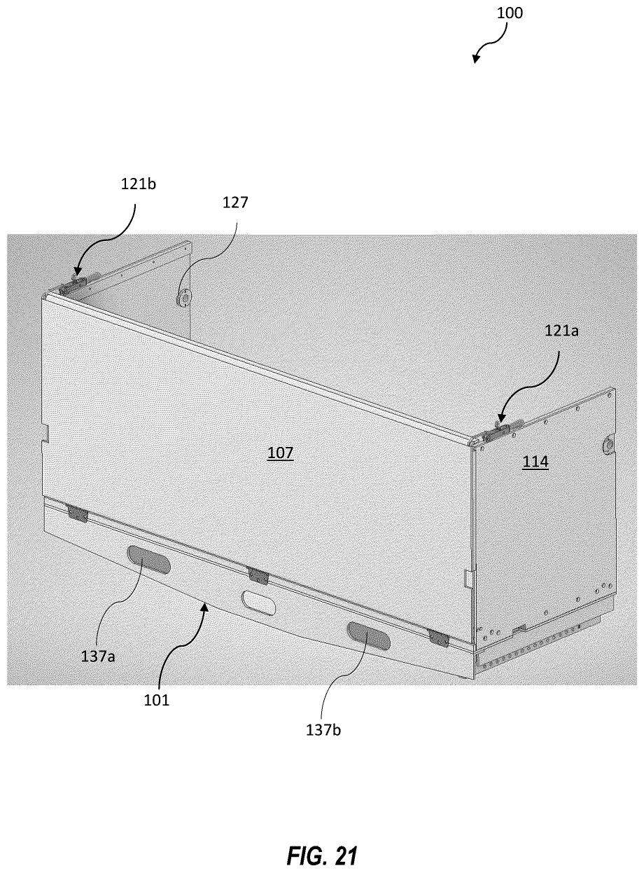

Referring now additionally to FIGS. 19-21, each latch 121a-121b of the first side panel 114 and the second side panel 115 illustratively includes a hand lever 134, and an arm 135 configured to engage with the first and second panel ends 112-113. The hand lever 134 is configured to lock the arm 135 in place. Also, each socket of the first side panel 114 and the second side panel 115 illustratively includes a spring loaded ball detent arrangement 136 for coupling to the tailgate striker bolt of the truck bed 109. The post 127 is opposite to spring loaded ball detent arrangement 136. Also, the extension assembly illustratively includes a plurality of brake light indicators 137a-137b carried by tailgate housing 101, providing brake light indicators when the tailgate device 100 is in use for extension (i.e., the OEM brake lights are not visible and are replaced).

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A tailgate device for a vehicle with a truck bed, the tailgate device comprising:
a tailgate housing having a first longitudinal side, a second longitudinal side opposite of the first longitudinal side, a first end between the first and second longitudinal sides, and a second end opposite the first end and between the first and second longitudinal sides, the first longitudinal side being pivotably coupled to a distal end of the truck bed, the tailgate housing providing access to the truck bed; and
an extension assembly carried by the tailgate housing and comprising
a panel having a first panel longitudinal side, a second panel longitudinal side opposite of the first panel longitudinal side, a first panel end between the first and second panel longitudinal sides, and a second panel end opposite the first panel end and between the first and second panel longitudinal sides, the first panel longitudinal side being pivotably coupled to the second longitudinal side of tailgate housing,
a first side panel pivotably coupled to the first end of the tailgate housing,
a second side panel pivotably coupled to the second end of the tailgate housing, and
first and second rails carrying a floor panel and configured to allow the floor panel to freely extend and retract longitudinally from a distal end of the truck bed, each of the first and second rails comprising a rack and pinion arrangement.
